(19) United States
(12) Patent Application Publication
(10) Pub. No.: US 2006/0196393 A1
(43) Pub. Date: Sep. 7, 2006

(54) Composite mineral counter tops

(75) Inventor: Buddy Rhodes, San Francisco, CA (US)

Correspondence Address: QUINE INTELLECTUAL PROPERTY LAW GROUP, P.C., P O BOX 458, ALAMEDA, CA, 94501, US

(73) Assignee: Buddy Rhodes Concrete Mix, Inc.

(21) Appl. No.: 11/368,351

(22) Filed: Mar. 3, 2006

Related U.S. Application Data
(60) Provisional application No. 60/658,860, filed on Mar. 4, 2005.

(51) Int. Cl. C04B 14/18; C04B 16/00; C04B 28/10; C04B 7/00

(52) U.S. Cl. 106/737; 106/698; 106/712; 106/718

(57) ABSTRACT

This invention provides compositions and methods for making mineral composites products. The compositions can include constituents such as, cement, sand, aggregate, clay, perlite, and marble dust. The methods can include preparation of a dry particulate composition, hydration of the composition, forming the hydrated composition into the general shape of the desired product and curing the composition into a substantially solid product.

### CROSS-REFERENCE TO RELATED APPLICATIONS

This application claims priority to and benefit of a prior U.S. Provisional Application No. 60/658,860, Composite Mineral Counter Tops, by Buddy Rhodes, filed Mar. 4, 2005. The full disclosure of the prior application is incorporated herein by reference.

### FIELD OF THE INVENTION

The present invention is in the field of mineral composites useful in the manufacture of household items and structures. Composites with particular proportions of cement, sand, aggregate and clay can solidify on addition of water to form useful products using methods of the invention.

### BACKGROUND OF THE INVENTION

Various forms of concrete have been known and used in structures and in ornamentation since at least the days of the Roman Empire. The early forms of cement were made by mixing volcanic ash with calcite powder. These naturally available ingredients were hard to come by and the physical properties of “concrete” prepared the cement were poor. In 1824, Joseph Aspdin, a bricklayer and mason in Leeds, England, took out a patent on a method to prepare portland cement. This invention was revolutionary because it greatly lowered the price and enhanced the quality of hydraulic mineral cements. Aspdin's method involved the careful proportioning of limestone and clay, pulverizing them, and burning the mixture into anhydrous clinker that could be ground into finely powdered cement.

Cement is a key ingredient in the preparation of concrete used in many objects, structures and surfaces around us in the modern world. A typical formula for concrete includes about 12% portland cement, 44% aggregate, 24% sand and 20% water, by weight. The composition is at first plastic and formable when water is added. The fresh wet concrete can be poured into forms to be shaped into desired objects and structures, spread out to form a solid surface. Ingredients of the cement, such as tricalcium silicate, dicalcium silicate, tricalcium aluminate, tetracalcium aluminoferrite, and gypsum can react with the added water to form hydrated products that crystallize around the other concrete components during the curing process. Over the course of several hours and days the crystallization continues while the concrete structure hardens.

Concrete is an excellent material for highways, structural supports in buildings and even for crude ornamental objects. However, concrete is a course gray material that can not take on a highly smooth surface or be formed in to highly detailed structures or surfaces.

Household structures and surfaces can be made of certain polymers or stone. However, stone is not malleable, so is difficult and expensive to work with. Polymers, such as plastics, are easy to form into fine surfaces and objects but they lack a hardness that is desired in many products, require toxic reactants to synthesize, and are generally not easy to dispose of when no longer of use.

In view of the above, a need exists for a material that is easy to work with for the fabrication of solid structures, objects and surfaces. It would be desirable to have a malleable material that can form a smooth or detailed surface which would harden into a strong attractive product. Benefits could also be realized from fine materials that are essentially natural and easily recyclable. The present invention provides these and other features that will be apparent upon review of the following.

### SUMMARY OF THE INVENTION

The present invention generally includes compositions and methods for preparing mineral composite products. The composition can include sand, aggregate, cement, and clay in proportions suitable for strong and intricate products, as desired. The methods can include hydration of the composition, forming it into the shape of a desired object and curing the composition.

The composition can include material that solidifies on addition of water or polymerization catalyst. The composition can include, e.g., 25 to 45 percent of a cement by dry weight, 10 to 44 percent sand by dry weight; 15 to 44 percent aggregate by dry weight, and 0 to 25 percent clay by dry weight. In another exemplary composition, the cement comprises 35 to 40 percent of the composition by dry weight; the sand comprises 15 to 20 percent of the composition by dry weight; the aggregate comprises 15 to 25 percent of the composition by dry weight; the clay comprises 5 to 10 percent of the composition by dry weight; and, the composition further comprises 10 to 20 percent marble dust by dry weight. In another embodiment, the composition comprises from about 32 percent to about 36 percent cement by dry weight, from about 17 percent to about 21 percent sand by dry weight, from about 40 percent to 44 percent of aggregate by dry weight, and from about 1 percent to about 5 percent of clay by dry weight. In a preferred embodiment, the composition comprises from about 32 percent to about 36 percent of cement by dry weight, from about 38 percent to about 42 percent of sand by dry weight, from about 19 percent to 23 percent of aggregate by dry weight, and from about 1 percent to about 5 percent of clay by dry weight. In many embodiments it is preferred to add a sparkling material, such as perlite, in amounts ranging, e.g., from about 0.5 percent to about 5 percent by dry weight. In a more preferred embodiment, the composition includes about 38 percent the cement, about 16 percent sand, about 19 percent aggregate, about 8 percent clay, about 17 percent marble dust by dry weight, and about 5 percent perlite by dry weight. For the purposes of formula calculations, the marble dust, perlite, and/or other mineral constituents (except the cement components) are considered additional aggregate, sand and/or clay percents, depending on their particle size and distribution.

Constituents of the composition can have particular qualities, modifiable for particular uses. For example, the cement can be calcined minerals, a polymerizable resin, portland cement, and/or the like. The sand can be, e.g., white silica having an average particle size ranging from about #16 to about #50 mesh. The aggregate be, e.g., marble with an average particle size ranging from about #5 to about #10 mesh. The clay can be, e.g., kaolin with an average particle size ranging from about #140 to about #325 mesh. The composition can optionally include, e.g., from about 1 percent to about 10 percent perlite by dry weight. The composition can have a coloring agent, such as a natural or synthetic pigment. In preferred embodiments the composition does not comprise more than about 10 weight percent each, or 10 weight percent either, of fly ash or reclaimed rock.

The composition can be hydrated to initiate reactions that, e.g., first plasticize, then solidify the composition. For example, a composition comprising portland cement can be suitably hydrated by addition of water to about 20 percent to about 40 percent of the hydrated composition to initiate crystallization and curing.

The invention includes objects, such as, e.g., furniture, ornamental objects, household surfaces or structural surfaces made entirely or in part from the composition described herein.

The present invention includes methods of fabricating objects or surfaces with the composite. For example, the method of forming a mineral composite product can include preparing a composition made up of 25 to 45 percent cement by dry weight, 10 to 44 percent sand by dry weight, 15 to 44 percent aggregate by dry weight, 0 to 25 percent clay by dry weight, and about 10 percent to about 40 percent water by total weight; forming the composition into the shape of the product; and, curing the composition to provide a substantially solid mineral composite product. The product can be, e.g., a counter top, table top, a floor, an ornamental object, and the like.

Forming the composition into a shape can include, e.g., placing the composition into a mold, spreading the composition, or pressing the material into a desired shape. The mold can have a textured surface and the mold can be separated the composition to expose a textured composition surface. For a smoother surface and pleasing appearance, e.g., a pigmented material can be applied to the textured surface. The mold can optionally have a hollow cavity the shape of a useful or decorative object and the mold can be releasable without significantly destroying the shape of the molded composition. Objects thus manufactured can receive a sealer to an exposed surface, e.g., to enhance water impermeability, gloss the finish, etc.

### DESCRIPTION OF THE DRAWINGS

FIG. 1 shows a schematic diagram of exemplary products formed from compositions of the invention using methods of the invention.

### DEFINITIONS

Unless otherwise defined herein or below in the remainder of the specification, all technical and scientific terms used herein have meanings commonly understood by those of ordinary skill in the art to which the present invention belongs.

Before describing the present invention in detail, it is to be understood that this invention is not limited to particular methods, compositions or structures, which can, of course, vary. It is also to be understood that the terminology used herein is for the purpose of describing particular embodiments only, and is not intended to be limiting. As used in this specification and the appended claims, the singular forms “a”, “an” and “the” include plural referents unless the content clearly dictates otherwise. Thus, for example, reference to “a component” can include a combination of two or more components; reference to “cement” can include mixtures of cements, and the like.

Although many methods and materials similar, modified, or equivalent to those described herein can be used in the practice of the present invention without undue experimentation, the preferred materials and methods are described herein. In describing and claiming the present invention, the following terminology will be used in accordance with the definitions set out below.

The term “cement”, as used herein, generally refers to a material that can be activated (e.g., by addition of water and/or a polymerization catalyst) to convert a particulate composition, in which the cement is a constituent, into a substantially solid structure by virtue of a chemical reaction. Typical cements of the invention comprise commonly known mineral cements, such as the notoriously well know and well characterized portland cement. Cements can include, e.g., a mixture of calcined limestone and clay, including, e.g., a powder of alumina, silica, lime, iron oxide, and magnesium oxide burned together in a kiln and finely pulverized. Such cements can be activated by addition of water and rendered a deformable material that can harden due to a chemical reaction (e.g., curing by hydration and crystallization processes) into a substantially solid structure. For purposes of defining the present invention, cement constituents, regardless of particle size, are not considered to be “clay”. Cements can alternately be polymerizable resins, such as, e.g., natural or synthetic resins that are curable by polymerization reactions to form substantially solid structures.

The term “sand”, as used herein, refers to mineral particles ranging in size from about 2 mm to about 0.1 mm. Sand commonly used in the methods and compositions are typically high in silicates.

The term “aggregate”, as used herein, refers to stones or other minerals ranging in size from about 100 mm to more than about 2 mm. Typical aggregate used in the invention includes marble particles ranging in average size from about 10 mm to about 2 mm.

The term “clay”, as used herein, refers to fine mineral particles with a size ranging from less than about 100 um to about 1 um. Typical clay of the compositions contains 25% or more aluminum oxides and 25% or more of silicates. Preferred clays of the invention are natural clays, rendered particulate through natural processes. For purposes of interpreting composition formulas of the invention, “clay”-sized particles, that may be present as a functional constituent of a cement, are not to be considered in the dry weight percent of “clay”. In an alternate aspect of the invention, clay is not material that was present during a calcining step of cement manufacture.

The term “dry weight”, as used herein, refers to the weight of the material dry. For example, dry weight of a composition can be the weight without the weight of unbound water. Dry weight can be precisely measured by incubating the material, at a temperature of 100° C. in air for a period of time until the weight of the material no longer drops significantly with additional incubation, before weighing the material.

Constituent particles of the present compositions are often not perfect spheres, but are typically irregular three dimensional shapes. The size of each individual particle, for classification purposes, is the average diameter of that particle. When reference is made herein to the “average particle size” of a composition component (such as, an aggregate, sand or clay component) contributing to composition formula, this indicates the size of the average particle in the population of particles in that component.

### DETAILED DESCRIPTION

The present invention includes mineral composite compositions and methods of using the composition. The composition can include components such as, e.g., cement, sand, clay, and aggregate. Methods can include, e.g., preparing the dry composition, hydrating the composition, forming the composition into a desired shape, and curing the composition to provide a solid product. The composition and methods are useful in preparation of household surfaces, structures, functional objects and ornamental objects.

Particulate Compositions

Compositions of the invention can include constituents, such as, e.g., cement, sand, clay and aggregate. The compositions can optionally include specific components, such as, e.g., clay, perlite, marble dust, water, air and the like. Typical compositions can be made to have a plastic rheology, and be activated, by the addition of water. Activated compositions can cure to form substantially solid structures. A preferred composition includes a combination of portland cement, white sand, marble aggregate, perlite, marble dust and kaolin. The overall composition provides constituents in a range of sizes and materials that work together to form a final product with unique and useful features such as, e.g., an ability to fill a bulk space with good strength in relatively thin pourings, the ability to present smoothness and/or fine detail at a surface, excellent working plasticity, and attractive appearance. These functional features are a result of composite elements working together in useful proportions described herein. The composite structure can include, e.g.: cement bound aggregate for strength and a grained appearance; cement bound sand to structurally support the space between the larger aggregate particles; a mixture of cement, clay and/or marble dust to provide a fine grain material that presents a finely detailed or smooth surface to and object. The composite elements work together in a combination that is optimum for many household goods and surfaces. In preferred embodiments the composition does not comprise more than about 10 weight percent each of fly ash, reclaimed concrete, or reclaimed rock.

As appearance is important, it is preferred that constituents of the composition be of clean grade. The non-aggregate constituents are preferably near white so that the color of the aggregate and/or added pigments can dominate the color. It is preferred that the average particle size of constituents be within a narrow range so that the hydrated composite works easily and predictably, and to provide a consistent surface.

The basic formula for particulate compositions of the invention includes mineral particles classified as either aggregate, sand or clay, depending on the size of the particles. The formula includes a cement component that is not considered any of aggregate, sand or clay for purposes of weight percent determinations. Some constituents identified in exemplary compositions of the invention can comprise particles classified as two or more of aggregate, sand and clay. These constituents can be considered to contribute to the formula weight percent of the two or more classes according to the weight proportion of the constituent particles in each class, unless expressly stated otherwise as additional.

In a preferred embodiment, the composition includes, e.g., 35 to 40 percent cement by dry weight; 15 to 20 percent sand by dry weight; 15 to 25 percent aggregate by dry weight; 5 to 10 percent clay by dry weight; and, an additional 10 to 20 percent marble dust by dry weight without regard to size distribution. In a most preferred embodiment, the composition includes, e.g., about 38 percent white portland cement by dry weight; about 16 percent 30 mesh silica by dry weight; about 19 percent #7 marble (imerys OZ) aggregate by dry weight; about 5 percent perlite by dry weight, about 5 percent clay (such as, Amador 200 or 200 mesh raw kaolin) by dry weight; and, about 17 additional percent marble dust (such as, Vical 1600, or microwhite 100) by dry weight.

Other preferred embodiments of the compositions can include, e.g., cement ranging from about 32 percent to about 36 percent of the composition by dry weight, sand ranging from about 17 percent to about 21 percent of the composition by dry weight, aggregate ranging from about 40 percent to 44 percent of the composition by dry weight, and clay ranging from about 1 percent to about 5 percent of the composition by dry weight. For example, the composition can consist essentially of 33.9% white cement, 18.93% Silica 30 bulk (sand), 21.4% commercial #7 marble (aggregate sized), 11.52% glass grade aggregate, 9.87% pool grade aggregate, 3.29% kaolin clay, and additional 1.09% perlite without regard to particle size.

In still other preferred embodiments, the compositions can include, e.g., cement ranging from about 32 percent to about 36 percent of the composition by dry weight, sand ranging from about 38 percent to about 42 percent of the composition by dry weight, aggregate ranging from about 19 percent to 23 percent of the composition by dry weight, and clay ranging from about 1 percent to about 5 percent of the composition by dry weight. For example, the composition can consist essentially of 33.9% white cement, 25% #20 mesh sand, 15.32% #30 mesh sand, 21% OZ white marble aggregate, 1.65% WC5 clay, 1.65% bell bottom clay and 1.09% perlite additional.

Cement

Cement in the invention can be, e.g., a material useful in composite compositions of the invention to provide a chemical reaction to substantially solidify the composition, e.g., from a deformable plastic rheology to a substantially solid product. Such cements can include, e.g., calcined minerals (such as portland cement) and/or organic polymers (such as epoxy resins and the like). Cement functions, e.g., to form a unified structure with particulate components of the compositions. In a preferred embodiment, the cement is white portland cement.

Cement can be present in the dry composition in amounts adequate to functionally solidify the mineral composite on activation and curing. For example, the cement can represent from about 10 percent to about 60 percent, from about 20 percent to about 50 percent, from about 25 percent to about 45 percent, from about 30 percent to about 40 percent, from about 35 percent to about 38 percent, or about 36 percent of the dry composition by weight.

Sand

Sand in the compositions can include mineral particles, e.g., in a size range useful for filling and strengthening spaces between aggregate particles of the composition. The sand is typically a silicate. Although general purpose sand can be used, it is preferred that the sand be a clean and white variety with a narrow particle size range. In a preferred embodiment the sand is a white sand high in silica. Sand in the composites can range in average particle size, e.g., from about 2 mm to about 0.1 mm, from about 1 mm to about 0.2 mm, from about 0.75 mm to about 0.3 mm, or about 0.5 mm. The mesh size of sand in the invention typically ranges from about #10 mesh to about #140 mesh, from about #16 mesh to about #50 mesh, or about #30 mesh. In a preferred embodiment, the sand comprises white silica having an average particle size ranging from about #16 to about #50 mesh. Conversion of mesh sizes to other particle size units is provided in Table 1, below.

TABLE 1
Mesh Sizes

| Mesh | Micron | Inches |
|---|---|---|
| 4 | 4760 | 0.185 |
| 6 | 3360 | 0.131 |
| 8 | 2380 | 0.093 |
| 12 | 1680 | 0.065 |
| 16 | 1190 | 0.046 |
| 20 | 840 | 0.0328 |
| 30 | 590 | 0.0232 |
| 40 | 420 | 0.0164 |
| 50 | 297 | 0.0116 |
| 60 | 250 | 0.0097 |
| 70 | 210 | 0.0082 |
| 80 | 177 | 0.0069 |
| 100 | 149 | 0.0058 |
| 140 | 105 | 0.0041 |
| 200 | 74 | 0.0029 |
| 230 | 62 | 0.0023 |
| 270 | 53 | 0.0021 |
| 325 | 44 | 0.0017 |
| 400 | 37 | 0.0015 |
| 625 | 20 | 0.0008 |
| 1250 | 10 | 0.0004 |
| 2500 | 5 | 0.0002 |

In preferred embodiments, the particles of the sand component are uniform in size. This aids, e.g., in the workability of the overall composition. In more preferred embodiments, the coefficient of variation (CV) for particle sizes of the sand component in a particulate composition is 100% or less, 50% or less, or 25% or less.

Sand can be present in the composition in amounts suitable to functionally support and fill spaces between the aggregate constituents. For example, sand can represent from about 5 percent to about 55 percent, from about 10 percent to about 50 percent, from about 15 percent to about 45 percent, from about 20 percent to about 40 percent, from about 25 percent to about 35 percent or about 30 percent of the dry particulate composition by weight.

Aggregate

Aggregate in the composition provides many functions. Aggregate can be a major portion of the composite bulk, the aggregate can have a desirable texture, color and appearance presented on the surface of finished products. Aggregate can be a major strengthening component because it is typically larger than other components and thus provides structural spans between other constituents.

Aggregate in the composition can be stones ranging in size from about 100 mm to about 2 mm in size (average diameter of the stone). The stones can be any mineral, but those preferred for their visual characteristics and workability include, e.g., calcite, limestone, and marble. Aggregate in the compositions typically range in average particle size from about 20 mm to about 2 mm, from about 15 mm to about 3 mm, from about 10 mm to about 4 mm, from about 8 mm to about 5 mm or about 6 mm. Mesh size for aggregate in the composition typically ranges, e.g., from about #2 mesh to about #10 mesh, from about #5 mesh to about #8 mesh, or about #7 mesh.

Aggregate can be present in the composition in amounts suitable to functionally strengthen the composite and provide a desired textural appearance. For example, aggregate can represent from about 5 percent to about 55 percent, from about 10 percent to about 47 percent, from about 16 percent to about 44 percent, from about 20 percent to about 35 percent or about 25 percent of the dry composition by weight.

Clay

Clay in the composition can have the function, e.g., of providing an enhanced plasticity to the hydrated composition, a smoother texture, and fine details in final products. Clay can provide these characteristics, e.g., by the microscopic slipping sheet structure it can provide. Clay can interact with water to provide the slippery almost greasy feel that is absent from classical concrete. These structural and functional characters are useful in the particular methods and final products of the invention. Preferred clay for compositions of the inventions can be, e.g., clays containing aluminum silicates, aluminum oxides, or silicates in significant amounts. The more preferred clays for the compositions are, e.g., kaolin clays, e.g., with an average particle size ranging from about #140 to about #325 mesh.

Clays used in the invention typically have average particle sizes ranging from about 100 um to about 0.5 um, from about 75 um to about 1 um, from about 50 um to about 2 um, or from about 20 um to about 5 um. Clay can be present in the composition in amounts suitable to provide the above stated beneficial characteristics. For example, clay can represent from about 0 percent to about 35 percent, from about 1 percent to about 30 percent, from about 2 percent to about 25 percent, from about 5 percent to about 15 percent or from about 7 percent to about 10 percent of the dry composition by weight.

Perlite

Perlite can be present in compositions of the invention, e.g., to add a sparkling appearance and for textural effects. Perlite used in the invention typically has a grain size ranging, e.g., from about 5 mm to about 0.1 mm, from about 2 mm to about 0.2 um, or from about 1 mm to about 0.5 mm. Perlite can be present in the composition in amounts desired for attractive appearance as long as strength is not excessively reduced for the particular use. Perlite can represent from about 0 percent to about 15 percent, from about 0.5 percent to about 10 percent, from about 1 percent to about 7 percent, or about 3 percent of the dry composition by weight.

In many formulations of the invention, although the perlite constituent may include particles sized, e.g., in the sand class, the perlite is typically considered an additional component, without regard to size classification.

Marble Dust

Marble dust in the compositions can play functional and aesthetic roles. The marble dust can play structural roles as a sand or clay. In addition the marble dust can lend its color and workable hardness to the composite. In many embodiments, the color of the marble dust can be similar to the color of the aggregate.

Marble dust is typically dust generated in the processing (e.g., sawing or grinding) of marble. Marble dust in the composition can have particles ranging in size from about 1 mm to about 1 um in average size (diameter). Marble dust in the compositions can have an average particle size ranging from about 1 mm to about 1 um, from about 0.5 mm to about 2 um, from about 0.25 mm to about 5 um, from about 0.1 mm to about 10 um or about 0.05 mm to about 20 um, or from about 400 um. In formulations of the invention, percent weight contribution of marble dust is typically considered in addition other (e.g., aggregate, sand or clay) components, regardless of particle size or distribution.

Marble dust can be present in the composition in amounts suitable to provide the desired appearance. Marble dust can represent in the particulate composition, e.g., from about 5 percent to about 45 percent, from about 10 percent to about 40 percent, from about 15 percent to about 35 percent, or about 20 percent of the dry composition by weight.

In many formulations of the invention, although the marble dust constituent may include particles sized, e.g., in the clay class, the marble dust is typically considered an additional component, without regard to size classification.

Water

Water can be added to the composition, where appropriate, in an amount adequate to provide a suitable plastic rheology to the composition for the selected purpose and method. Water should be added in an amount that will ultimately provide a strong product, without cracking on curing and drying of the hydrated composition. The composition for use, e.g., in forming objects, structures, or surfaces can have water added in a quantity sufficient to comprise from about 10 percent to about 45 percent, from about 20 percent to about 40 percent, from about 25 percent to about 35 percent, or about 30 percent of the hydrated composition by weight. Preferred water is pure and clean, e.g., without uncontrolled salts. Surface active agents can be added to facilitate suspension of composite constituents. Pigments or coloring agents can be added to color the final product.

Additional Structure

Additional structural members can be added to many of the mineral composite objects, structures, or surfaces fabricated from the compositions of the invention. For example, meshworks of metal or polymer fibers can be placed within the plastic hydrated composition as it is formed into the desired product. Although the composites generally have very high compressive strength, provision of additional structures with good tensile strength can enhance the crack resistance and durability of final products made from the compositions.

Methods of Fabricating Mineral Composite Products

Methods of fabrication mineral composite products generally require preparation of a suitable composition, hydration of the composition, forming the composition into the desired shape and allowing the product to cure. Selection of a proper starting composition can include consideration of factors such as color, strength, texture, plasticity, thickness of the product, and the like.

In a typical method of forming a mineral composite product, a composition is prepared generally as described above in the Particulate Compositions section. For example, the composition can include admixture of 25 to 45 percent cement by dry weight; 10 to 44 percent sand by dry weight; 16 to 44 percent aggregate by dry weight; and, 0 to 25 percent clay by dry weight. Water can be added to form a final hydrated composition with from about 10 percent to about 40 percent water by total hydrated composition weight.

The hydrated composition can be formed in the shape of the desired product. For example the composition can be trowelled in a layer to form a floor, wall, ceiling, or counter top. The applied material can be smoothed or textured using tools known in the art. The material can be poured into any number of different molds to take on a predetermined shape. The material can be pressed or shaped into a desired shape manually or using machines such as tampers or potter's wheels.

When forming work is complete, the hydrated composition can be cured to convert a plastic hydrated material to a solid set product. Generally, curing takes place under standard (ambient) conditions of heat and humidity. In some cases, the product can be warmed or cooled to control the rate of curing and the quality of the final product. In some cases, the product can be held, e.g., in a humid environment, surrounded by damp materials, or under water, to slow curing for an improved strength or to prevent drying of the surface. Curing can take place over a few minutes, hours, days, or months. The product can generally be handled within hours or days, e.g., to remove the product from a mold.

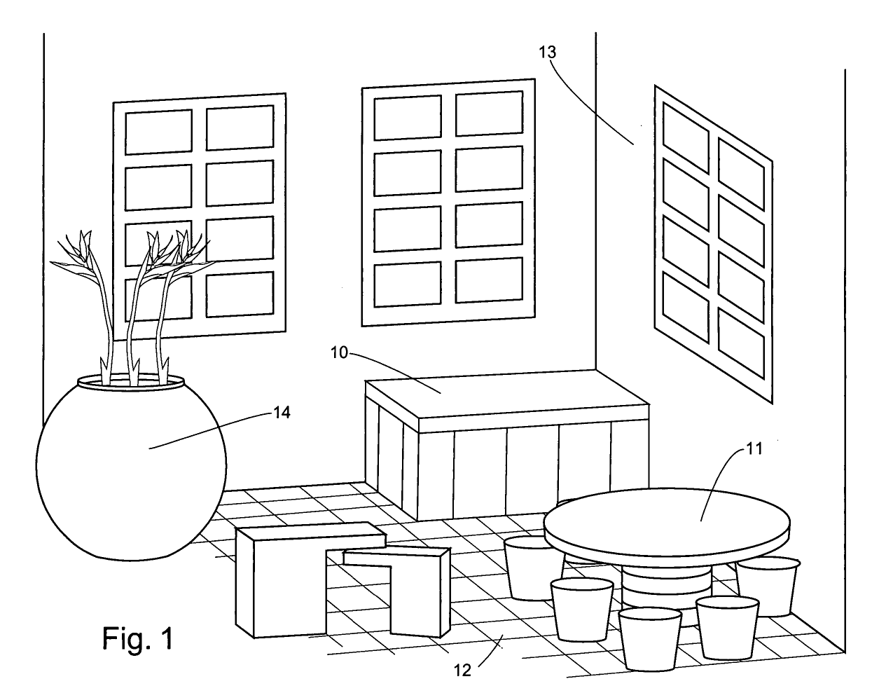

Methods of the invention can be used to produce a variety of solid products of many shapes. For example, products can include functional and/or ornamental structures, such as counter tops 10, table tops 11, floors 12, walls 13, containers 14, etc. (see, FIG. 1).

Counter Tops

Counter tops can be fabricated using methods and compositions of the invention. Such counter tops can be made on site or they can be made elsewhere and installed. The tops can have special edges, textures and appearances.

In one embodiment, the countertop is formed by preparing the hydrated composition, and shaping the product by pouring or pressing the material into a mold having about the size and shape of the desired counter top. The mold can be slightly larger than the desired top to take account of shrinkage during curing, and to allow trimming for custom fits installments. The mold can have a texture, e.g., inspired from a natural material, such as the veins of polished marble, waves, wood, etc., or repeated or geometric patterns. The texture can be impressed into the plastic composition where it can remain during and after curing. A pigmented cement material, such as a grout, can be applied over the texture and the excess rubbed or squeegeed off leaving a smooth flat surface that retains the texture as a visual pattern of the surface.

In other embodiments, the prepared hydrated composition can be pressed or poured into a mold that includes a hollow cavity the shape of a useful or decorative object, such as a vase, dish, statuette, etc. In many cases it can be desirable to coat the mold with a release compound to facilitate removal of the mold from the object. During or after curing, the mold can be separated from the object for final processing (e.g., trimming or painting), curing or drying.

In many cases, it is desirable to apply a paint or sealant to the product to protect and enhance the beauty of the product. The sealant can include, e.g., a natural resin, wax or oil. Optionally, the sealant can be a synthetic polymer.

It is understood that the examples and embodiments described herein are for illustrative purposes only and that various modifications or changes in light thereof will be suggested to persons skilled in the art and are to be included within the spirit and purview of this application and scope of the appended claims.

While the foregoing invention has been described in some detail for purposes of clarity and understanding, it will be clear to one skilled in the art from a reading of this disclosure that various changes in form and detail can be made without departing from the true scope of the invention. For example, many of the techniques and compositions described above can be used in various combinations.

All publications, patents, patent applications, and/or other documents cited in this application are incorporated by reference in their entirety for all purposes to the same extent as if each individual publication, patent, patent application, and/or other document were individually indicated to be incorporated by reference for all purposes.

What is claimed is:

1. A particulate composition that solidifies after addition of water, the composition comprising:
25 to 45 percent cement by dry weight;
10 to 44 percent sand by dry weight;
16 to 44 percent aggregate by dry weight; and,
0 to 25 percent clay by dry weight;
wherein the composition undergoes a chemical reaction on addition of water to form a solid structure.

2. The composition of claim 1, wherein the cement is selected from the group consisting of: calcined minerals, a polymerizable resin or portland cement.

3. The composition of claim 1, wherein the sand comprises white silica having an average particle size ranging from about #16 to about #50 mesh.

4. The composition of claim 1, wherein the aggregate comprises marble.

5. The composition of claim 4, wherein the marble aggregate has an average particle size ranging from about #5 to about #10 mesh.

6. The composition of claim 1, wherein the composition comprises from about 3 percent to about 8 percent of the clay by dry weight.

7. The composition of claim 1, wherein the clay comprises kaolin.

8. The composition of claim 7, wherein the kaolin has an average particle size ranging from about #140 to about #325 mesh.

9. The composition of claim 1, further comprising from about 1 percent to about 10 percent perlite by dry weight.

10. The composition of claim 1, further comprising a coloring agent.

11. The composition of claim 1, after addition of water in a quantity sufficient to comprise from about 20 percent to about 40 percent of the hydrated composition by weight.

12. The composition of claim 1, wherein:
the cement comprises 35 to 40 percent of the composition by dry weight;
the sand comprises 15 to 20 percent of the composition by dry weight;
the aggregate comprises 16 to 25 percent of the composition by dry weight;
the clay comprises 5 to 10 percent of the composition by dry weight; and,
the composition further comprises 10 to 20 percent marble dust by dry weight.

13. The composition of claim 1, wherein the composition does not comprise more than about 10 weight percent each of fly ash or reclaimed rock.

14. The composition of claim 1, wherein:
the cement comprises about 38 percent of the composition by dry weight;
the sand comprises about 16 percent of the composition by dry weight;
the aggregate comprises about 19 percent of the composition by dry weight;
the clay comprises about 8 percent of the composition by dry weight;
the composition further comprises about 17 percent marble dust by dry weight; and,
the composition further comprises about 5 percent perlite by dry weight.

15. The composition of claim 1, wherein:
the cement comprises from about 32 percent to about 36 percent of the composition by dry weight;
the sand comprises from about 17 percent to about 21 percent of the composition by dry weight;
the aggregate comprises from about 40 percent to 44 percent of the composition by dry weight; and,
the clay comprises from about 1 percent to about 5 percent of the composition by dry weight.

16. The composition of claim 15, further comprising from about 0.5 percent to about 5 percent perlite by dry weight.

17. The composition of claim 1, wherein:
the cement comprises from about 32 percent to about 36 percent of the composition by dry weight;
the sand comprises from about 38 percent to about 42 percent of the composition by dry weight;
the aggregate comprises from about 19 percent to 23 percent of the composition by dry weight; and,
the clay comprises from about 1 percent to about 5 percent of the composition by dry weight.

18. The composition of claim 17, further comprising from about 0.5 percent to about 5 percent perlite by dry weight.

19. Furniture, ornamental objects, household surfaces or structural surfaces comprising the composition of claim 1.

20. A method of forming a mineral composite product, the method comprising:
preparing a composition comprising:
25 to 45 percent cement by dry weight;
10 to 44 percent sand by dry weight;
16 to 44 percent aggregate by dry weight;
0 to 25 percent clay by dry weight; and,
about 10 percent to about 40 percent water by total weight;
forming the composition into the shape of the product; and
curing the composition to provide a substantially solid mineral composite product.

21. The method of claim 20, wherein the product is selected from the group consisting of: a counter top, table top, a floor, and an ornamental object.

22. The method of claim 20, wherein said forming comprises placing the composition into a mold.

23. The method of claim 22, wherein the mold comprises a textured surface, and further comprising:
separating the composition from the mold to expose a textured composition surface; and,
applying a pigmented material to the textured surface.

24. The method of claim 22, wherein the mold comprises a hollow cavity the shape of a useful or decorative object, and further comprising separating the composition from the mold to release the object.

25. The method of claim 20, wherein the cement comprises: calcined minerals, a polymerizable resin or portland cement.

26. The method of claim 20, wherein the sand comprises white silica.

27. The method of claim 20, wherein the aggregate comprises marble.

28. The method of claim 20, wherein the clay comprises kaolin.

29. The method of claim 20, wherein the composition does not comprise more than about 10 weight percent each of fly ash or reclaimed rock.

30. The method of claim 20, wherein the composition further comprises from about 1 percent to about 10 percent perlite by dry weight.

31. The method of claim 20, wherein the composition further comprises a coloring agent.

32. The method of claim 20, wherein the composition further comprises from about 10 percent to about 20 percent marble dust by dry weight.

33. The method of claim 20, further comprising:
applying a sealer to an exposed surface of the composite product.
